(19) United States
(12) Patent Application Publication
(10) Pub. No.: US 2005/0232721 A1
(43) Pub. Date: Oct. 20, 2005

(54) Expansion anchor

(76) Inventor: Yao-Chin Nieh, Banciao City (TW)

Correspondence Address: Yi-Wen Tseng, 4331 Stevens Battle Lane, Fairfax, VA, 22033, US

(21) Appl. No.: 10/823,750

(22) Filed: Apr. 14, 2004

(51) Int. Cl. F16B 13/04

(52) U.S. Cl. 411/57.1

(57) ABSTRACT

An expansion anchor includes a screw body, an expansion unit and a plug. The screw body has a threaded part, a header and a connecting part which connects to one end of the expansion unit. The expansion unit is shaped in a ring-like sleeve and has multiple gutters along axis direction at the other end of the unit which allows a cambered surface being formed between two adjacent gutters, where the number of cambered surfaces equals to the number of gutters. In addition, a conical plug is used to fit into the guttered end of expansion unit. The fact that screw body is separated from the plug shortens the time needed for installation and increases the degree of tightness. It achieves quick installation and firm positioning purpose.

### BACKGROUND OF THE INVENTION

The present invention relates to a structural improvement to an expansion anchor, specifically, the kind of which can be firmly secured in a pre-drilled hole on wall. It shortens the time needed to install and increases the tightness between the anchor and wall.

Expansion anchors are widely used in daily applications as to hanging pictures, securing water/gas pipes and storage structure. It's been extensively researched on how can they be quickly and securely installed.

Referring to FIG. 1, commonly known expansion anchor includes a screw body 10a and an expansion unit 20a. The front end of the body 10a is threaded and the back end has a fitting section 12a which is shaped in a cone, where the smaller end of cone connects to the threaded end. Also, expansion unit 20a is shaped in ring-like sleeve and there are multiple gutters 21a at the back end to allow a cambered surface 22a being formed between two adjacent gutters. The screw body 10a passes through the expansion unit 20a from back end of the unit connecting two pieces together. At installation, a hole is drilled on the wall, and washer and nut have to be taken off the screw body 10a; then expansion anchor is inserted into the hole by pounding an extension pipe (not shown) against the end of expansion unit 20a.

However, in practical application commonly used expansion anchor has problems as follows.

First, before installation, the washer and nut have to be taken off the screw body then be put back on since the nut, washer, screw body and expansion unit are assembled together. This configuration increases the time need, i.e., the cost of installation. It's apparent not economical.

Second, when the nut being tighten the screw body 10a is being forced to rotated in opposite direction where the fitting cone 12a can not be seen from outside so that over tightening could cause the larger end of the cone 12a is completely pressed into the expansion unit 20a and the expansion anchor being pulled out of wall.

To resolve the problems caused by the conventional expansion anchors as described above, with many years of experience in this field, a structural improvement to an expansion anchor has been developed as described as follows.

### BRIEF SUMMARY OF THE INVENTION

The present invention provides a structural improvement to an expansion anchor, specifically, the kind of which can be firmly secured in a pre-drilled hole on wall. It shortens the time needed to install and increases the tightness between the screw and wall to achieve quick and secure installation.

The present invention includes a screw body, an expansion unit and a plug. The screw body has a threaded part, a header and a connecting part which connects to one end of the expansion unit. The expansion unit is shaped in a ring-like sleeve and has multiple gutters along axis direction at the other end of the unit which allows a cambered surface being formed between two adjacent gutters, where the number of cambered surfaces equals to the number of gutters. In addition, a conical plug is used to fit into the guttered end of expansion unit.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These as well as other features of the present invention will become more apparent upon reference to the drawings therein:

FIG. 1 depicts an application of a conventional expansion anchor.

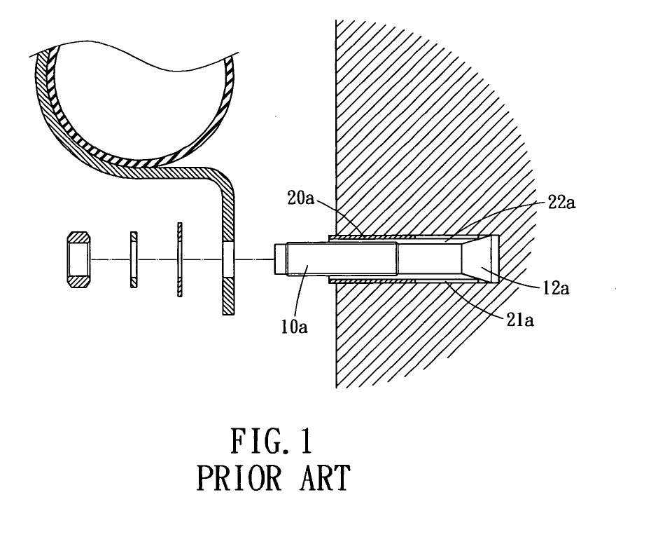

FIG. 2 depicts a perspective view of the expansion anchor of the present invention.

FIG. 3 depicts assembly of the expansion anchor of the present invention.

FIG. 4 depicts a cross-sectional view of assembled expansion anchor of the present invention.

FIG. 5 depicts the expansion anchor of the present invention used in mounting a pipe.

FIG. 6 depicts the expansion anchor of the present invention after mounting the pipe.

FIG. 7 depicts a cross-sectional view of the assembled expansion anchor according to another preferred embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

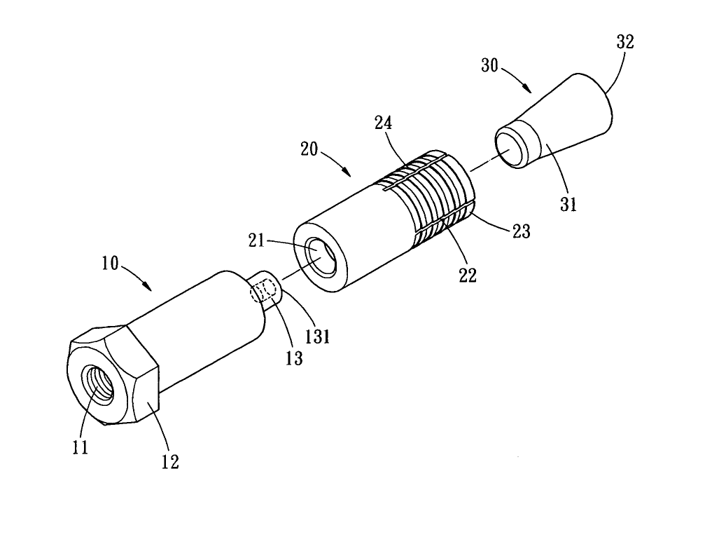

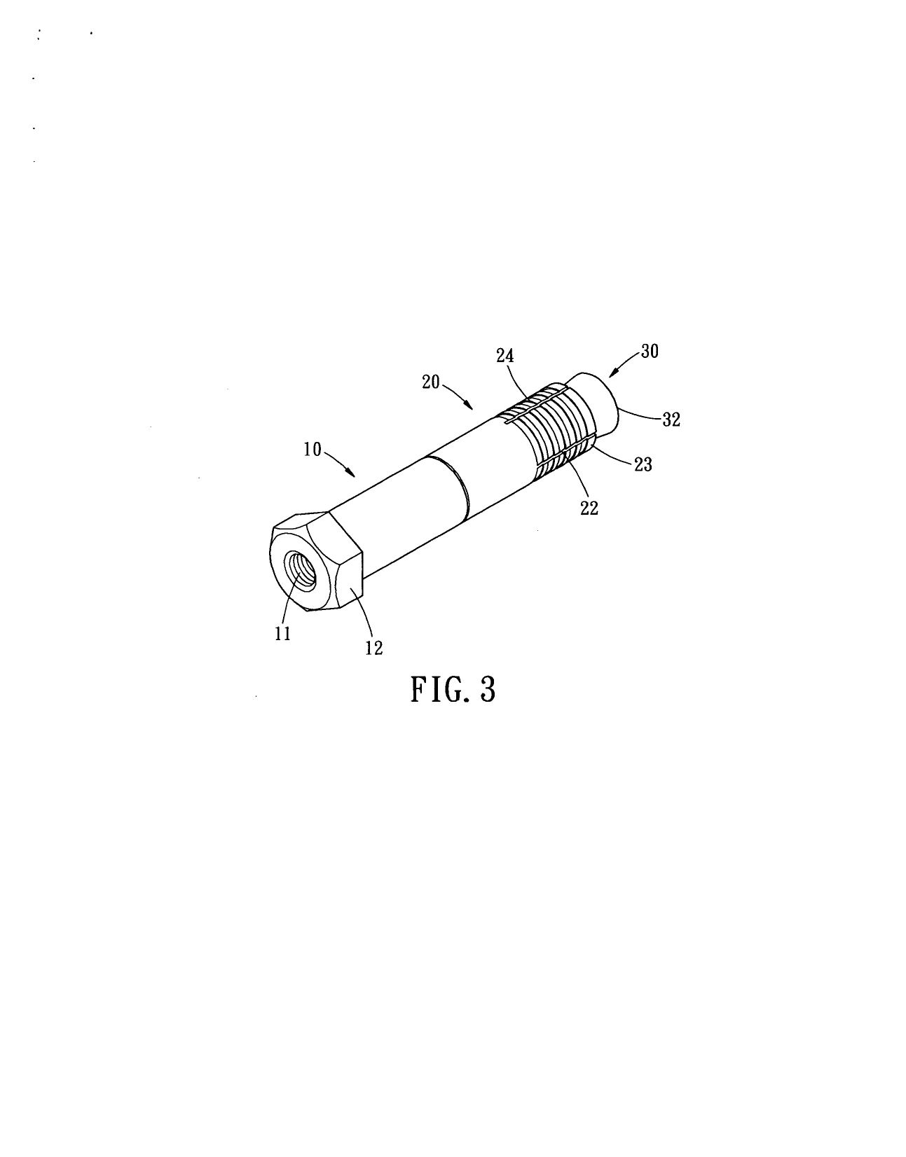

Referring to FIGS. 2-4, the present invention provides structural improvement to an expansion anchor which includes a screw body 10, an expansion unit 20 and a plug 30.

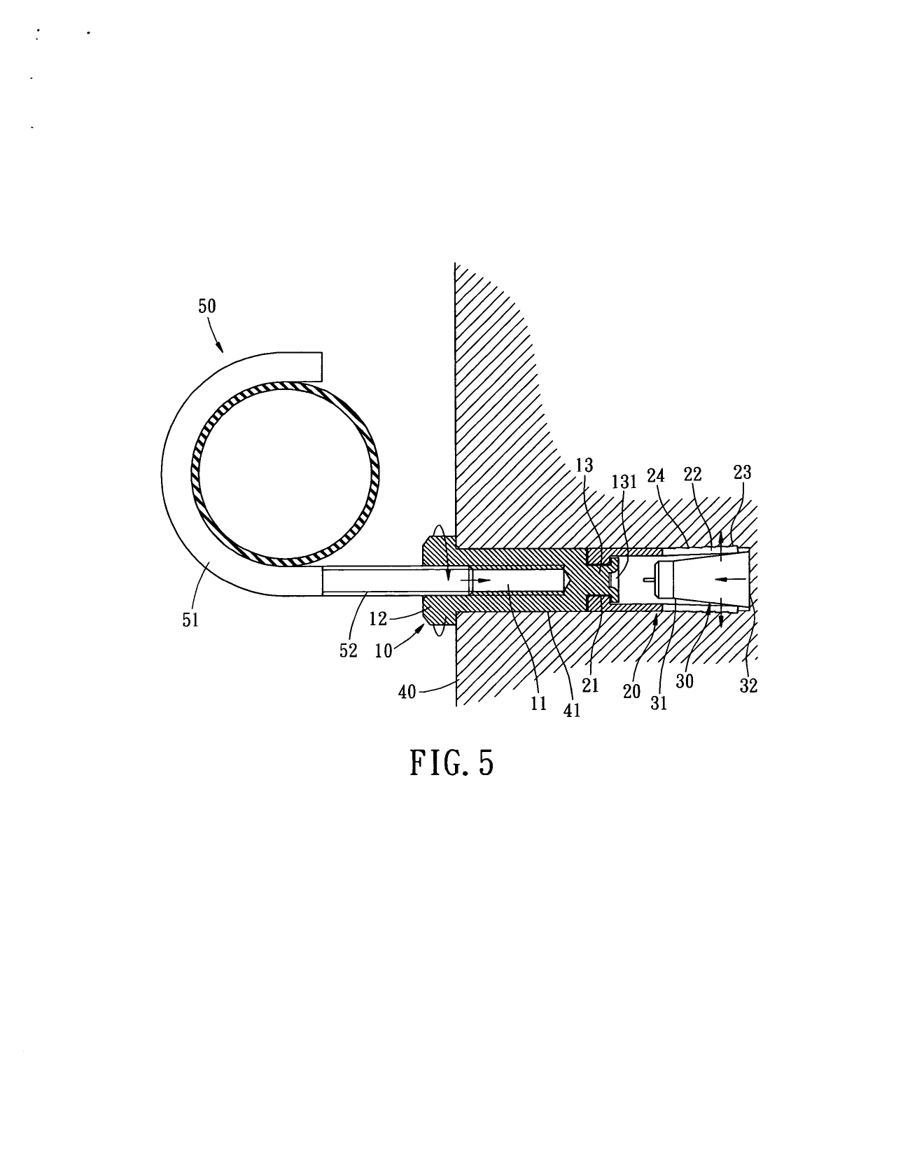

The screw body 10 is a circular cylinder. One end of the screw body 10 is a header 12 and is threaded internally 11. The other end of the screw body 10 is a connecting end 13. The header 12 can be shaped in either hex or square (it is hex in this preferred embodiment) to be rotated by spanner or other tools. The connecting end 13 is shaped in a round rod and there is a hole 131 at the center (see FIG. 5) to be used to be riveted to the expansion unit 20.

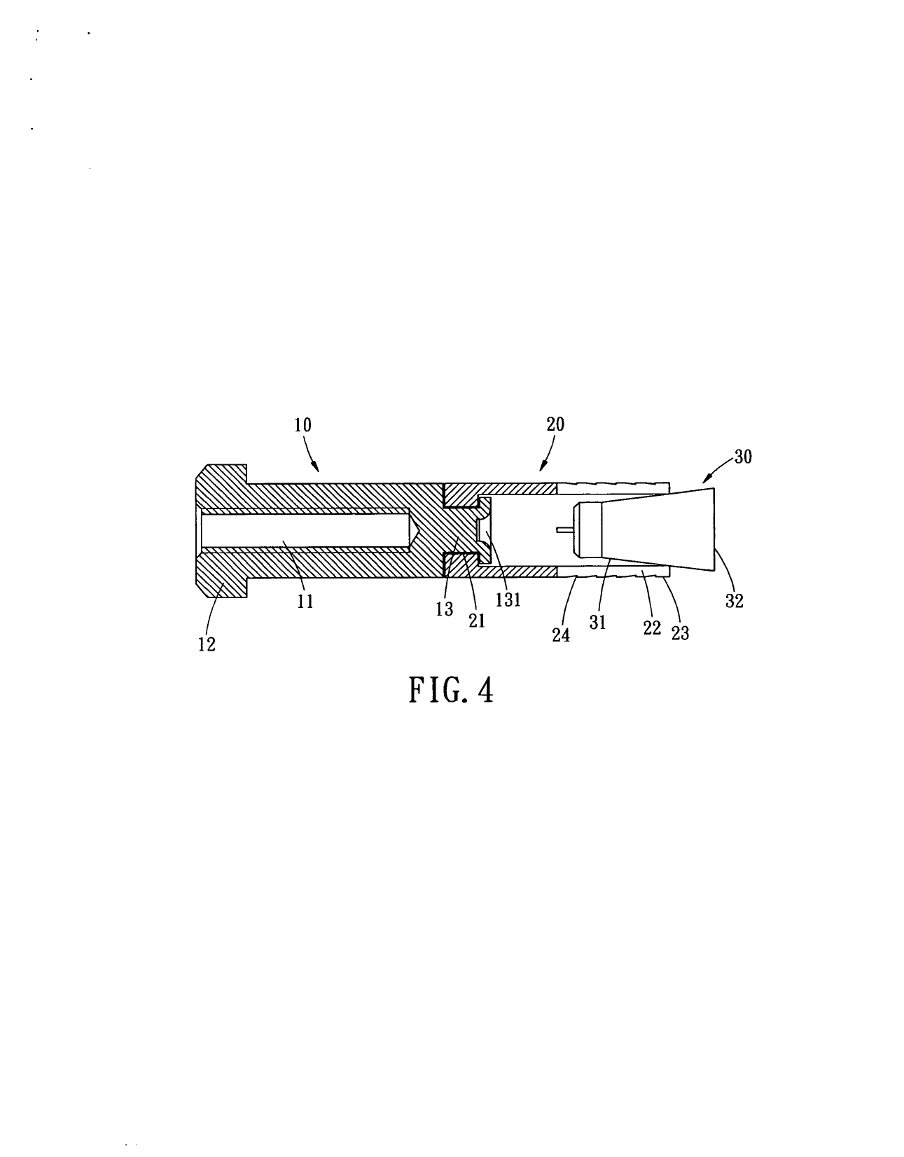

The expansion unit 20 is shaped in a ring-like sleeve. There is a hole 21 at front end of the expansion unit 20 to be riveted through connecting end 13 of the screw body 10 as in FIG. 4. At back end of the expansion unit 20, there are multiple gutters 22 parallel with axis, which allows a cambered surface 23 being formed between two adjacent gutters 22, where the number of cambered surfaces 23 equals to the number of gutters 22. In addition, the outer surface 24 of back end of the expansion unit 20 where cambered surfaces 23 are formed is grooved multiple times to increase overall gripping strength of the expansion unit 20.

The plug 30 can be shaped in either a round cone or a multi-side cone. It is a round cone in this preferred embodiment and has a smaller end 31 and larger end 32. The diameter of smaller end 31 is smaller than the inner diameter of guttered end 22 of the expansion unit 20 whereas the larger end 32 is bigger than the inner diameter of guttered end 22 of the expansion unit 20 so that the smaller end 31 of the plug 30 can be inserted into the expansion unit 20 at guttered end 22.

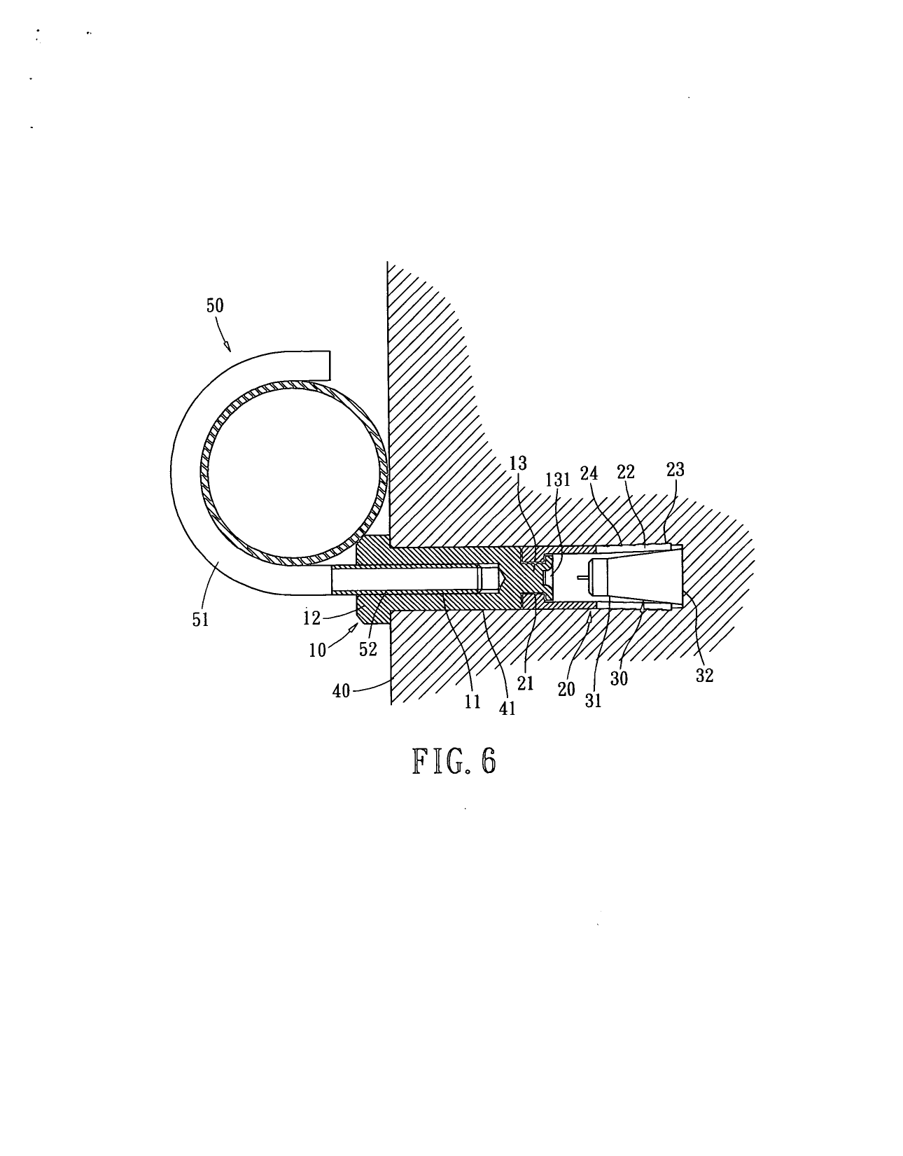

Referring to FIGS. 5 and 6, the present invention is applied in securing pipes at two distinctive stages. At installation, a hole 41 is drilled on wall 40 and one end of the expansion anchor is inserted into the hole; then a pounding tool (i.e. a hammer) can be used to hit directly on the header 12 of screw body 10 and forces expansion anchor into the hole 41. Because the bottom of plug 30 is against the bottom of hole 41, when the screw body 10 moves in it presses the expansion unit 20 toward the bottom of plug 30 such that the cambered surfaces 23 of the expansion unit 20 are expanded outward and embedded firmly inside the hole 41 around the wall. In addition, the thread part 11 of screw body 10 can be used in connecting a standard securing hook 50, which has a hook part 51 and a screw part 52. The hook is shaped in round arc being used to secure variety of pipes (for example, water/gas pipe) and the screw part 52 can be used to connect to the thread part 11 of the screw body 10 so that the hook 51 embraces around the pipe. The header 12 of screw body 10 can be twisted by a tool or hands directly so that the hook 50 is moved toward the wall 40 securing the pipe.

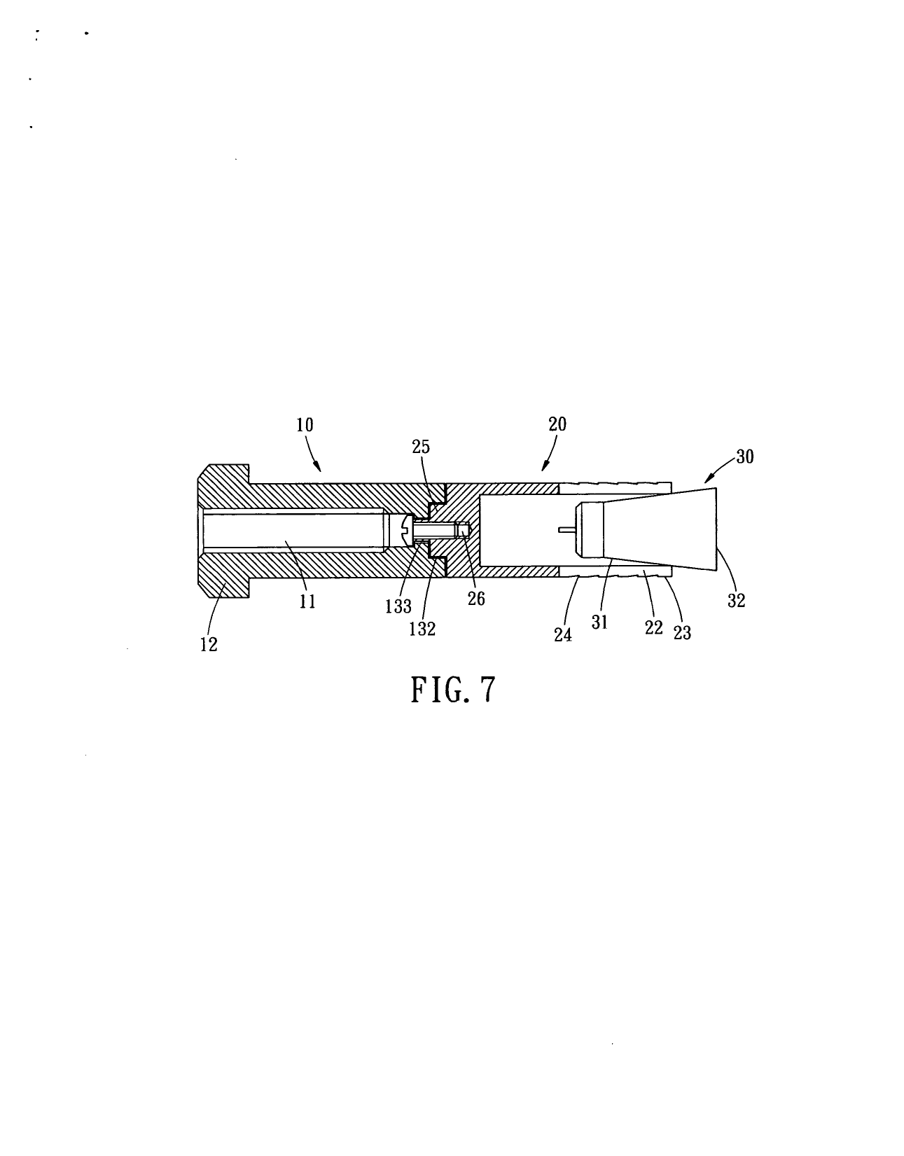

Please refer to FIG. 7. The connecting part 13 of screw body 10 consists of a larger hole 132 and a smaller hole 133. At front end of the expansion unit 20 is a raised rod (or convex) 25 with a threaded hole 26, where the raised rod 26 can fit right into the larger hole 132 of screw body 10 and the threaded hole 26 matches the smaller hole 133 of screw body 10. A screw connects the screw body 10 tightly to the expansion unit 20 through the threaded hole 26, but the screw body 10 can be rotated around expansion unit 20.

As fore mentioned, the present invention of improved expansion anchor has following advantages: because the header 12 of the expansion anchor can be pounded directly into a hole 41 on wall by a tool, there is no need to disassemble before installation and reduces the time and cost dramatically. Also, since the screw body 10 is separated from the plug 30, when the screw body 10 is tighten, the plug 30 will not be forced to rotated in opposite direction as to pulling the whole expansion anchor out of wall. Last, screw body 10 can be made to match one same-size standard securing hook 50 when used in mounting pipes and reduce the number of expansion anchor needed.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

1. An expansion anchor, comprising:
an expansion unit shaped in a ring-like sleeve, including a plurality of gutters along an axis direction at first end which allows a cambered surface being formed between two adjacent gutters, wherein a number of the cambered surfaces equals to a number of the gutters;
a screw body including a threaded part, a header and a connecting part which connects to the expansion unit at a second end; and
a plug shaped in cone, being used to fit into the first end of the expansion unit.

2. The expansion anchor of claim 1, wherein the screw body is a circular cylinder.

3. The expansion anchor of claim 1, wherein the threaded part is internally threaded.

4. The expansion anchor of claim 1, wherein the header is shaped in hex.

5. The expansion anchor of claim 1, wherein the header is shaped in square.

6. The expansion anchor of claim 1, wherein the connecting part of the screw body is a round rod, and there is a hole in the expansion unit which allows the connecting rod fitting right into and connecting the screw body and the expansion unit.

7. The expansion anchor of claim 1, wherein the connecting part of the screw body includes a larger and a smaller holes; there are a raised rod and a threaded hole at the second end of the expansion unit and the raised rod fits right into the larger hole and the threaded hole matches the smaller hole; the screw body is connected to the expansion unit by a screw.

8. The expansion anchor of claim 1, wherein the outer diameter of the expansion unit is larger than the outer diameter of the screw body.

9. The expansion anchor of claim 1, wherein the outer surface of the expansion unit at guttered end, where the cambered surfaces are located, is grooved multiple times to increase gripping strength of the expansion unit.

10. The expansion anchor of claim 1, wherein the plug is a round cone or a multi-side cone.
